(19) United States
(12) Patent Application Publication
(10) Pub. No.: US 2021/0059332 A1
(43) Pub. Date: Mar. 4, 2021

(54) Massage Garment Apparatus

(71) Applicant: Saul J. Fernandez, Chula Vista, CA (US)

(72) Inventor: Saul J. Fernandez, Chula Vista, CA (US)

(21) Appl. No.: 16/559,851

(22) Filed: Sep. 4, 2019

(51) Int. Cl. A41D 27/20; A61H 23/02; A41B 1/10; A41D 1/06

(52) U.S. Cl. CPC A41D 27/205; A61H 23/0263; A41B 1/10; A41D 1/06; A41D 27/201; A41B 2400/322; A61H 2201/5002; A41B 2300/326; A41B 2300/324; A41D 2400/322; A61H 2201/0207; A61H 2201/501; A61H 2201/165; A41B 2300/322

(57) ABSTRACT

A massage garment apparatus for automatically receiving massages includes a garment having a plurality of pockets. Each pocket has a pocket opening and a closure mechanism. A plurality of massage pads is each selectively engageable within the plurality of pockets. Each massage pad comprises a pad body. An array of vibrators is coupled within the pad body. A microprocessor is coupled within the pad body and is in operational communication with the array of vibrators. A battery is coupled within the pad body and is in operational communication with the array of vibrators and the microprocessor. A charge port is coupled to the pad edge and is in operational communication with the battery. A receiver is coupled within the pad body and is in operational communication with the array of vibrators, the microprocessor, and the battery. The receiver is configured to communicate with a smartphone.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to massage devices and more particularly pertains to a new massage device for automatically receiving massages.

(2) Description of Related Art including information disclosed under 37 CFR 1.97 and 1.98.

The prior art relates to massage devices.

### BRIEF SUMMARY OF THE INVENTION

An embodiment of the disclosure meets the needs presented above by generally comprising a garment having a plurality of pockets. Each pocket has a pocket opening and a closure mechanism. A plurality of massage pads is each selectively engageable within the plurality of pockets. Each massage pad comprises a pad body having a pad top side, a pad bottom side, and a pad edge defining a pad inside. An array of vibrators is coupled within the pad body. A microprocessor is coupled within the pad body and is in operational communication with the array of vibrators. A battery is coupled within the pad body and is in operational communication with the array of vibrators and the microprocessor. A charge port is coupled to the pad edge and is in operational communication with the battery. A receiver is coupled within the pad body and is in operational communication with the array of vibrators, the microprocessor, and the battery. The receiver is configured to communicate with a smartphone.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a massage garment apparatus according to an embodiment of the disclosure.

FIG. 2 is a front elevation view of an embodiment of the disclosure.

FIG. 3 is a rear elevation view of an embodiment of the disclosure.

FIG. 4 is an isometric view of an embodiment of the disclosure.

FIG. 5 is an isometric view of an embodiment of the disclosure.

FIG. 6 is a cross-sectional view along the line 1-1 of FIG. 5 of an embodiment of the disclosure.

FIG. 7 is a front elevation view of an embodiment of the disclosure.

FIG. 8 is a rear elevation view of an embodiment of the disclosure.

### DETAILED DESCRIPTION OF THE INVENTION

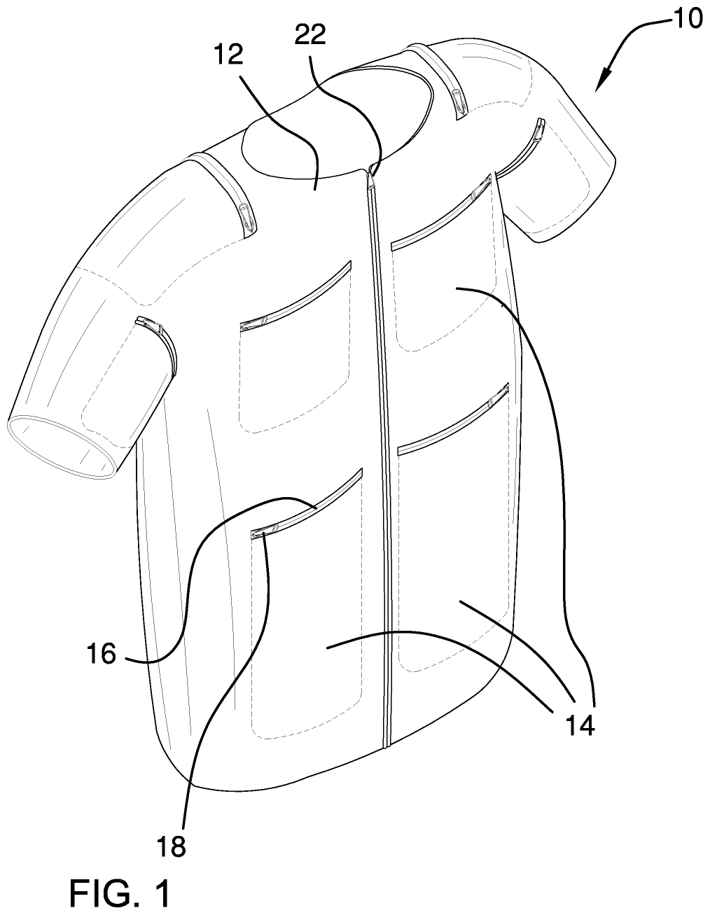

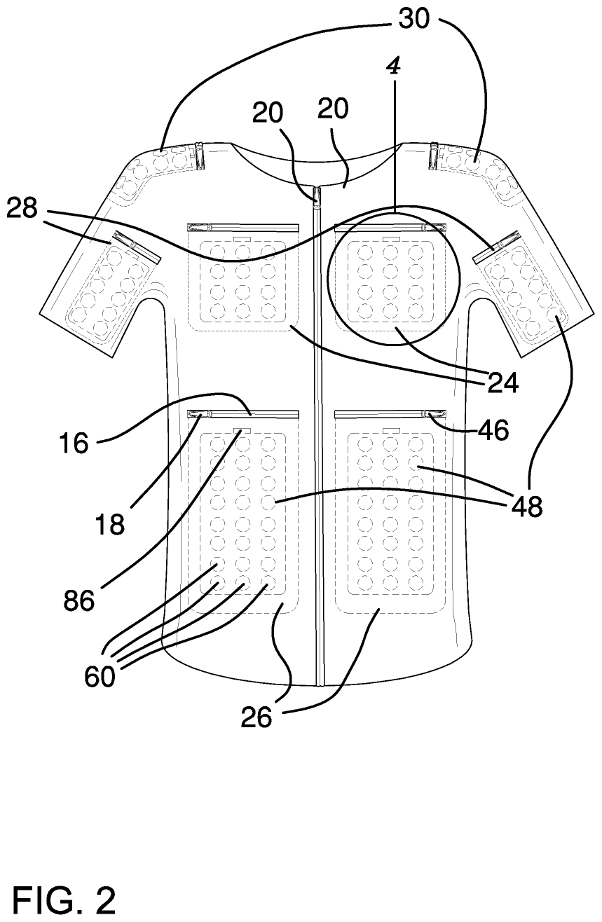

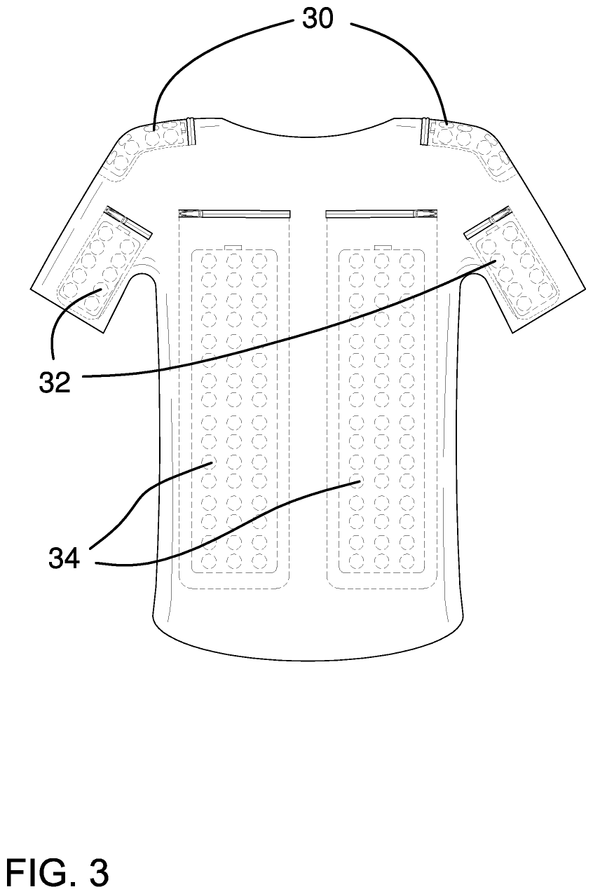

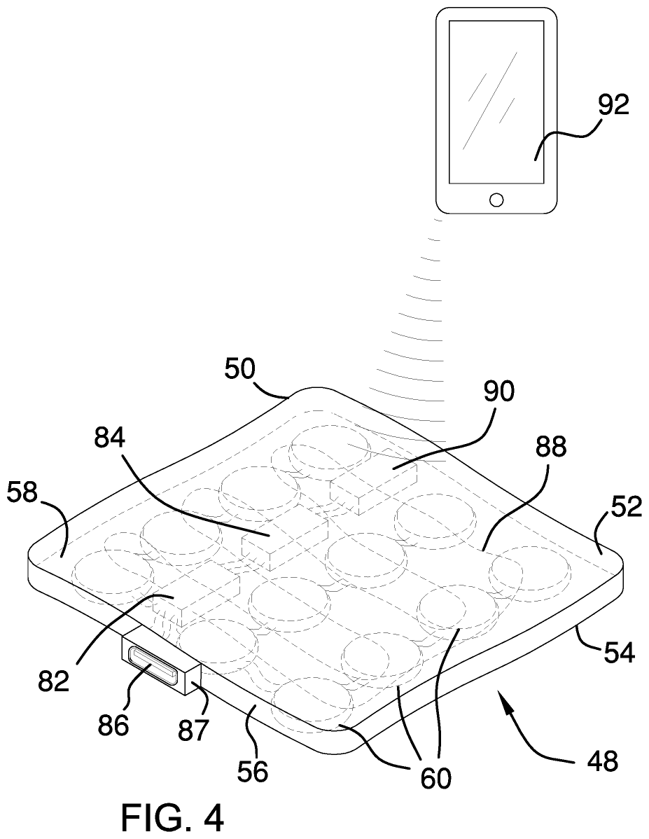

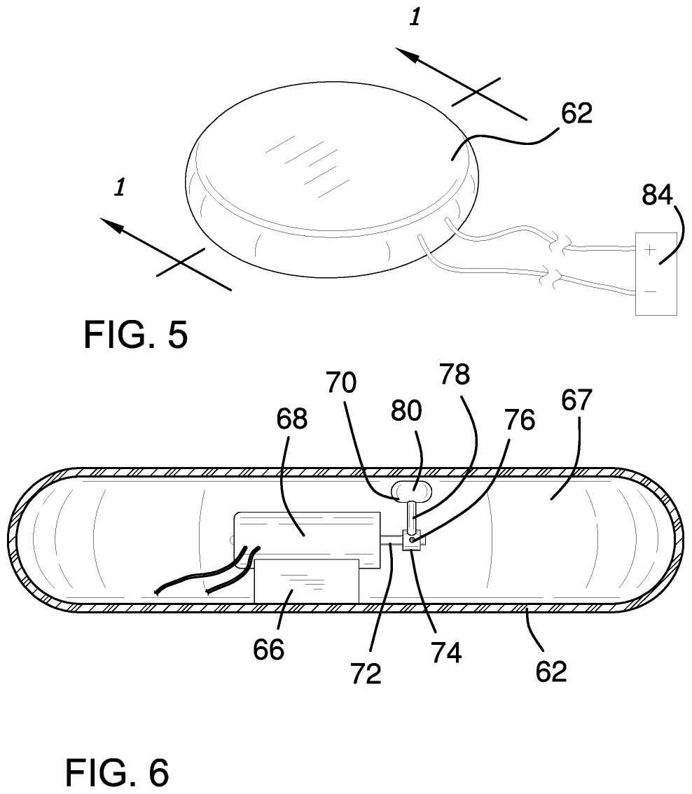

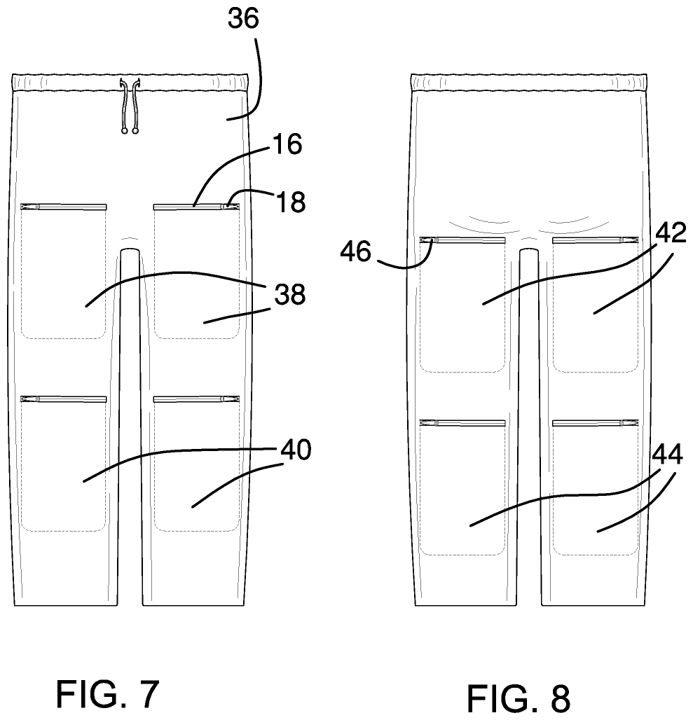

With reference now to the drawings, and in particular to FIGS. 1 through 8 thereof, a new massage device embodying the principles and concepts of an embodiment of the disclosure and generally designated by the reference numeral 10 will be described.

As best illustrated in FIGS. 1 through 8, the massage garment apparatus 10 generally comprises a garment 12 having a plurality of pockets 14. Each pocket 14 has a pocket opening 16 and a closure mechanism 18. The garment 12 is a shirt 20 having a front zipper 22. The plurality pockets 14 comprises a pair of breast pockets 24, a pair of abdominal pockets 26, a pair of front sleeve pockets 28, a pair of shoulder pockets 30, a pair of back sleeve pockets 32, and a pair of back pockets 34. The garment 12 may alternatively be a pair of pants 36 having a pair of front thigh pockets 38, a pair of front shin pockets 40, a pair of back thigh pockets 42, and a pair of back calf pockets 44. The closure mechanism 18 may be a zipper 46 or other closure mechanism including, but not limited to, a hook-and-loop fastener, buttons, snaps, and the like.

A plurality of massage pads 48 is selectively engageable within the plurality of pockets 14. Each massage pad 48 comprises a pad body 50 having a pad top side 52, a pad bottom side 54, and a pad edge 56 defining a pad inside 58.

An array of vibrators 60 is coupled within the pad body 50. Each vibrator 60 has a disc-shaped shell body 62 having a rounded perimeter and defining a shell inside 64. Each vibrator 60 has a motor mount 66 coupled to the shell body 62 within the shell inside 64, a motor 68 coupled to the motor mount 66, and an eccentric rotating mass 70 coupled to a motor shaft 72 of the motor 68. The eccentric rotating mass 70 has a sleeve 74 coupled to the motor shaft 72 with a set screw 76. An extension arm 78 extends from the sleeve 74 perpendicular to the motor shaft 72. A mass head 80 is coupled to the extension arm 78. The array of vibrators 60 of the massage pads 48 is coupled within the breast pockets 24, the abdominal pockets 26, and the back pockets 34 may be three columns wide while the array of vibrators of the massage pads coupled within the front sleeve pockets 28, the shoulder pockets 30, and the back sleeve pockets 32 may be two columns wide. A microprocessor 82 is coupled within the pad body 50 and is in operational communication with the array of vibrators 60. A battery 84 is coupled within the pad body 50 and is in operational communication with the array of vibrators 60 and the microprocessor 82. A charge port 86 is coupled to the pad edge 56 and is in operational communication with the battery 84. The charge port 86 may have a rectangular prismatic port extension 87 coupled to the pad edge 56. A heating element 88 is coupled within the pad body 50 and is in operational communication with the battery 84 and the microprocessor 82. A receiver 90 is coupled within the pad body 50 and is in operational communication with the array of vibrators 60, the microprocessor 82, and the battery 84. The receiver 90 is configured to communicate with a smartphone 92.

In use, the user wears the garment 12 and uses her smartphone 92 to communicate with the receiver 90, which in turn communicates with the array of vibrators 60, the microprocessor 82, and the battery 84. The array of vibrators 60 simulates a variety of massage techniques including, but not limited to, kneading, rolling, and vibrating only to relax the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massage garment apparatus comprising:
a garment, the garment having a plurality of pockets, each pocket having a pocket opening and a closure mechanism; and
a plurality of massage pads, each massage pad being selectively engageable within the plurality of pockets, each massage pad comprising:
a pad body having a pad top side, a pad bottom side, and a pad edge defining a pad inside;
an array of vibrators coupled to the pad body, the array of vibrators being coupled within the pad body;
a microprocessor coupled to the pad body, the microprocessor being coupled within the pad body and being in operational communication with the array of vibrators;
a battery coupled to the pad body, the battery being coupled within the pad body and being in operational communication with the array of vibrators and the microprocessor;
a charge port coupled to the pad body, the charge port being coupled to the pad edge and being in operational communication with the battery; and
a receiver coupled to the pad body, the receiver being coupled within the pad body and being in operational communication with the array of vibrators, the microprocessor, and the battery, the receiver being configured to communicate with a smartphone.

2. The massage garment apparatus of claim 1 further comprising each vibrator having a disc-shaped shell body having a rounded perimeter and defining a shell inside.

3. The massage garment apparatus of claim 2 further comprising each vibrator having a motor mount coupled to the shell body within the shell inside, a motor coupled to the motor mount, and an eccentric rotating mass coupled to a motor shaft of the motor.

4. The massage garment apparatus of claim 3 further comprising the eccentric rotating mass having a sleeve coupled to the motor shaft with a set screw, an extension arm extending from the sleeve perpendicular to the motor shaft, and a mass head coupled to the extension arm.

5. The massage garment apparatus of claim 1 further comprising a heating element coupled to the pad body, the heating element being coupled within the pad body and being in operational communication with the battery and the microprocessor.

6. The massage garment apparatus of claim 1 further comprising the garment being a shirt having a front zipper.

7. The massage garment apparatus of claim 6 further comprising the plurality pockets comprising a pair of breast pockets, a pair of abdominal pockets, a pair of front sleeve pockets, a pair of shoulder pockets, a pair of back sleeve pockets, and a pair of back pockets.

8. The massage garment apparatus of claim 1 further comprising the garment being a pair of pants.

9. The massage garment apparatus of claim 8 further comprising the pair of pants having a pair of front thigh pockets, a pair of front shin pockets, a pair of back thigh pockets, and a pair of back calf pockets.

10. The massage garment apparatus of claim 1 further comprising the closure mechanism being a zipper or other closure mechanism including, but not limited to, a hook-and-loop fastener, buttons, snaps, and the like.

11. A massage garment apparatus comprising:
a garment, the garment having a plurality of pockets, each pocket having a pocket opening and a closure mechanism, the garment being a shirt having a front zipper, the plurality pockets comprising a pair of breast pockets, a pair of abdominal pockets, a pair of front sleeve pockets, a pair of shoulder pockets, a pair of back sleeve pockets, and a pair of back pockets, the closure mechanism being a zipper or other closure mechanism including, but not limited to, a hook-and-loop fastener, buttons, snaps, and the like; and
a plurality of massage pads, each massage pad being selectively engageable within the plurality of pockets, each massage pad comprising:
a pad body having a pad top side, a pad bottom side, and a pad edge defining a pad inside;
an array of vibrators coupled to the pad body, the array of vibrators being coupled within the pad body, each vibrator having a disc-shaped shell body having a rounded perimeter and defining a shell inside, each vibrator having a motor mount coupled to the shell body within the shell inside, a motor coupled to the motor mount, and an eccentric rotating mass coupled to a motor shaft of the motor, the eccentric rotating mass having a sleeve coupled to the motor shaft with a set screw, an extension arm extending from the sleeve perpendicular to the motor shaft, and a mass head coupled to the extension arm;
a microprocessor coupled to the pad body, the microprocessor being coupled within the pad body and being in operational communication with the array of vibrators;
a battery coupled to the pad body, the battery being coupled within the pad body and being in operational communication with the array of vibrators and the microprocessor;
a charge port coupled to the pad body, the charge port being coupled to the pad edge and being in operational communication with the battery;
a heating element coupled to the pad body, the heating element being coupled within the pad body and being in operational communication with the battery and the microprocessor; and
a receiver coupled to the pad body, the receiver being coupled within the pad body and being in operational communication with the array of vibrators, the microprocessor, and the battery, the receiver being configured to communicate with a smartphone.
